(19) United States
(12) Patent Application Publication
(10) Pub. No.: US 2025/0327962 A1
(43) Pub. Date: Oct. 23, 2025

(54) POOL EQUIPMENT WITH LIGHT GUIDES

(71) Applicant: ZODIAC POOL CARE EUROPE, Belberaud (FR)

(72) Inventor: Arnaud Besnier, Beaupuy (FR)

(73) Assignee: ZODIAC POOL CARE EUROPE, Belberaud (FR)

(21) Appl. No.: 19/182,594

(22) Filed: Apr. 18, 2025

Related U.S. Application Data
(60) Provisional application No. 63/637,655, filed on Apr. 23, 2024.

(51) Int. Cl. F21V 8/00; E04H 4/14

(52) U.S. Cl. CPC G02B 6/0008; E04H 4/148

(57) ABSTRACT

Pool equipment for a swimming pool or spa includes a dry electrical compartment and at least one light guide for conducting light signals to and/or from the dry electrical compartment. A method may include conducting light signals from a light emitter onboard a piece of pool equipment and through water using a light guide. Additionally, or alternatively, a method may include conducting light signals from an external location, through water, and to a piece of pool equipment using a light guide.

### REFERENCE TO RELATED APPLICATIONS

This application claims the benefit of and priority to U.S. Provisional Patent Application No. 63/637,655, filed on Apr. 23, 2024, and entitled POOL EQUIPMENT WITH LIGHT GUIDES, the content of which is hereby incorporated by reference in its entirety.

### FIELD OF THE INVENTION

The invention relates to swimming pools and spas, and more particularly, although not necessarily exclusively, to systems and methods for communicating with equipment of the swimming pools and spas.

### BACKGROUND OF THE INVENTION

Swimming pools and spas are commonly used for a variety of recreational and other purposes and include various associated equipment such as but not limited to pool cleaners, docking stations, water chlorinators, pumps, heat pumps, sensors, pool lights, etc. Certain pool equipment may have or be light-emitting features for a variety of purposes such as communication, lighting, visual effects, etc. However, light signals from traditional equipment may be limited in a pool environment due to improperly placed or oriented equipment sending and/or receiving the light signals, the effects of water on light signals, etc.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various embodiments of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, pool equipment for a swimming pool or spa includes a dry electrical compartment and at least one light guide for conducting light signals to and/or from the dry electrical compartment.

According to various embodiments, a method includes conducting light signals from a light emitter onboard a piece of pool equipment and through water using a light guide.

According to some embodiments, a method includes conducting light signals from an external location, through water, and to a piece of pool equipment using a light guide.

Various implementations described in the present disclosure can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following FIGURES are illustrated to emphasize the general principles of the present disclosure. Corresponding features and components throughout the FIGURES can be designated by matching reference characters for the sake of consistency and clarity.

FIG. 1 illustrates a pool system with pool equipment according to embodiments.

### DESCRIPTION OF THE INVENTION

Described herein are systems and methods providing improved conducting or conveyance of light signals from pool equipment and through water of a swimming pool or spa. In certain embodiments, the systems and methods described herein may conduct light emitted from a light source of the pool equipment (i) from a dry electronic compartment or chassis of the pool equipment, (ii) through water of the swimming pool or spa, and (iii) to a dedicated area for any purpose, such as but not limited to communication, lighting, visual effects, combinations thereof, and/or as otherwise desired. In various embodiments, the systems and methods described herein may provide improved guiding or conducting of the light signals as an emission (e.g., generated by the pool equipment) and/or reception (e.g., received by the pool equipment).

In some embodiments, the systems and methods described herein may include a guiding body and/or sub-assembly with an embedded light guide to guide light from the chassis to an external face of the pool equipment, or vice versa. In certain embodiments, an electronic connection between the guiding body and the chassis is not required, and the guiding body may position the light guide relative to a light source of the chassis. In some cases, the lack of electrical connection between the guiding body and the light source may provide a modular solution to guiding light to and/or from the chassis and may facilitate installation and/or disassembly of the guide body. The light signals conducted by the systems and methods described herein may be provided for various purposes, such as but not limited to communication, lighting, visual effects, sensing, combinations thereof, and/or as otherwise desired. As non-limiting examples, the light signals conducted by the systems and methods described herein may be utilized for time of flight sensing, LiFi communication, on/off (proximity) sensing, water detection, touch sensing, combinations thereof, and/or as otherwise desired. Various other benefits and advantages may be realized with the systems, devices, and methods provided herein, and the aforementioned advantages should not be considered limiting.

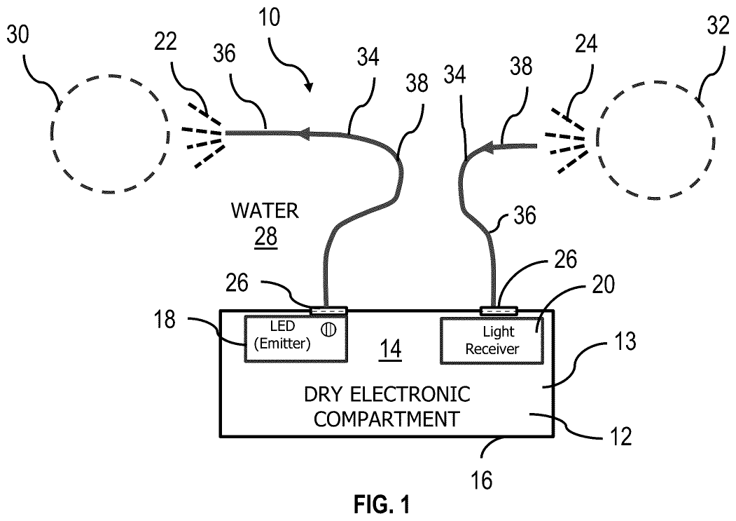

FIG. 1 illustrates a pool system 10 with pool equipment 12 according to embodiments. The pool equipment 12 may be various types of pool equipment as desired, such as but not limited to water chlorinators, pumps, heat pumps, automatic pool cleaners, pool lights, combinations thereof, and/or other equipment as desired. In some embodiments, the pool equipment 12 may be movable within a pool, although in other embodiments the pool equipment 12 may be at a fixed or particular location relative to the pool.

In one non-limiting example, the pool equipment 12 is a self-propelled pool cleaner 13 (e.g., self-propelled). Self-propelled pool cleaners capable of autonomous or semi-autonomous movement within swimming pools and spas. In some embodiments, the self-propelled pool cleaner 13 is an automatic swimming pool cleaner, which may be hydraulic or robotic in type. Hydraulic cleaners vary water flow for movement, while robotic cleaners typically employ electric motors to cause motion. Hydraulic pool cleaners, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

The automatic pool cleaner 13 generally includes a body and one or more motive elements (e.g., wheels, tracks, feet, etc.). A pump, filter assembly, cleaning device such as a brush assembly or other suitable device, any suitable electric or other motors, a controller (e.g., processor and memory), a communication module, an on-board power source (e.g., rechargeable batteries), and/or various other features may be provided on or within the automatic pool cleaner 13 as desired. In some cases, the automatic pool cleaner 13 need not be a robotic automatic pool cleaner 13 and thus may not have an on-board power source. The automatic pool cleaner 13 may be various types of pool cleaners as desired. Non-limiting examples of automatic pool cleaners 13 may include those described in U.S. Pat. Nos. 10,316,534, 9,488,154, 8,578,538, and U.S. Patent Publication No. 2014/0303810, all of which are hereby incorporated by reference in their entireties.

Regardless of the specific type of pool equipment 12, as illustrated in FIG. 1, the pool equipment 12 generally includes a chassis 16 with a dry electrical compartment 14, In certain embodiments, the pool equipment 12 includes one or more light emitters 18 for emitting light signals 22 and/or one or more light receivers 20 for receiving light signals 24. In other embodiments, the pool equipment 12 need not include both light emitter(s) 18 and light receiver(s) 20. Optionally, the chassis 16 includes one or more features enabling the reception of light signals 24 into the dry electrical compartment 14 and/or the emission of light signals 22 from the dry electrical compartment 14. In some cases, the features may be windows 26 and/or other transparent and/or translucent features as desired.

In various embodiments, and as illustrated in FIG. 1, the pool equipment 12 may be provided at least partially within water 28 of the pool such that the light signals 22, 24 must be transmitted through the water 28 to be received and/or sent by the pool equipment 12. However, in addition to effects of the water 28 on the light signal transmission, the pool equipment 12 may be arranged and/or positioned within the water 28 in an orientation unsuitable and/or with reduced effectiveness for directing the light signals 22 to a desired area 30 and/or for receiving the light signals 24 from a desired area 32. The desired areas 30, 32 may be various locations on or within the pool system 10, such as but not limited to communication areas, sensing areas, lighting areas, visual effect areas, combinations thereof, and/or as otherwise desired.

As illustrated in FIG. 1, in various embodiments, one or more guiding devices 34 may be provided for guiding light signals 22, 24 to and/or from the pool equipment 12 to desired areas 30, 32. Any number of guiding devices 34 may be utilized, and the number, type, shape, and/or orientation of the guiding devices 34 should not be considered limiting. In certain embodiments, each guiding device 34 includes a body 36 with an embedded light guide 38. The light guide 38 may be various types of light guides as desired, such as but not limited to optical fiber, liquid light guides, glass light guides, plastic light guides, and/or other types or combinations of light guides as desired. In some embodiments, the guiding device 34 with the light guide 38 may be relatively rigid or fixed in shape, while in other embodiments the guiding device 34 with the light guide 38 may have an adjustable shape.

In certain embodiments, the guiding devices 34 are arranged relative to the dry electrical compartment 14 such that they are positioned relative to the light emitter 18 and/or the light receiver 20 without being electronically connected to the light emitter 18 and/or the light receiver 20. Without electronic connections between the guiding devices 34 and the light emitter 18 and/or the light receiver 20, the pool equipment 12 may have a modular assembly with improved assembly and/or disassembly of the guiding devices 34 with the pool equipment 12. With such positioning of the light guides 38 without electronic connections, the light signals 22 emitted by the light emitter 18 may be received by the guiding device 34, conducted through the water 28, and conducted to the desired area 30. Similarly, the light signals 24 emitted by the desired area 32 may be received by the guiding device 34, conducted through the water 28, and conducted to the light receiver 20. It is again noted that the light signals 24 from the desired area 32 and received by the light receiver 20 may be generated by another device and/or may be sensed information. As a non-limiting example, the sensed light signals 24 may be sunlight and used by the pool equipment to determine a time of day, weather condition, etc. Various other types of light signals 24 may be received as desired.

Exemplary concepts or combinations of features of the invention may include:
A. Pool equipment for a swimming pool or spa, wherein the pool equipment comprises a dry electrical compartment and at least one light guide for conducting light signals to and/or from the dry electrical compartment.
B. A method comprising conducting light signals from a light emitter onboard a piece of pool equipment and through water using a light guide.
C. A method comprising conducting light signals from an external location, through water, and to a piece of pool equipment using a light guide.
D. Pool equipment according to any preceding or subsequent statement or combination of statements, further comprising a light emitter within the dry electrical compartment.
E. Pool equipment according to any preceding or subsequent statement or combination of statements, further comprising a light receiver within the dry electrical compartment.
F. Pool equipment according to any preceding or subsequent statement or combination of statements, wherein the light guide is embedded within a guiding device.
G. Pool equipment according to any preceding or subsequent statement or combination of statements, wherein the light guide is rigid or flexible.
H. Pool equipment according to any preceding or subsequent statement or combination of statements, wherein the light guide is not electronically connected to the dry electrical compartment.
I. Pool equipment according to any preceding or subsequent statement or combination of statements, wherein the light signal is a communication signal, a lighting signal, a visual effect signal, and/or a sensing signal.
J. Pool equipment according to any preceding or subsequent statement or combination of statements, wherein the light signal is a time of flight signal, a LiFi signal, a proximity sensor, a water sensor, and/or a touch sensor.
K. Pool equipment according to any preceding or subsequent statement or combination of statements, wherein the light guide is configured to guide a light signal in emission and/or reception.
L. Pool equipment according to any preceding or subsequent statement or combination of statements, wherein the light guide comprises optical fiber.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pool equipment, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. Pool equipment for a swimming pool or spa, wherein the pool equipment comprises a dry electrical compartment and at least one light guide for conducting light signals to and/or from the dry electrical compartment.

2. The pool equipment of claim 1, further comprising a light emitter within the dry electrical compartment.

3. The pool equipment of claim 2, further comprising a light receiver within the dry electrical compartment.

4. The pool equipment of claim 1, further comprising a light receiver within the dry electrical compartment.

5. The pool equipment of claim 1, wherein the light guide is embedded within a guiding device.

6. The pool equipment of claim 1, wherein the light guide is rigid or flexible.

7. The pool equipment of claim 1, wherein the light guide is not electronically connected to the dry electrical compartment.

8. The pool equipment of claim 1, wherein the light signal is a communication signal, a lighting signal, a visual effect signal, and/or a sensing signal.

9. The pool equipment of claim 1, wherein the light signal is a time of flight signal, a LiFi signal, a proximity sensor, a water sensor, and/or a touch sensor.

10. The pool equipment of claim 1, wherein the light guide is configured to guide a light signal in emission and/or reception.

11. The pool equipment of claim 1, wherein the light guide comprises optical fiber.

12. The pool equipment of claim 1, wherein the pool equipment is at least one of a pool cleaner, a water chlorinator, a pump, a heat pump, or a pool light.

13. A method comprising conducting light signals from a light emitter onboard a piece of pool equipment and through water using a light guide.

14. The method of claim 13, wherein the pool equipment comprises a dry electrical compartment, wherein the light emitter is within the dry electrical compartment and wherein the light guide conducts light signals from the dry electrical compartment.

15. The method of claim 13, wherein the light signals are communication signals, lighting signals, visual effect signals, and/or a sensing signals.

16. The method of claim 13, wherein the pool equipment is at least one of a pool cleaner, a water chlorinator, a pump, a heat pump, or a pool light.

17. A method comprising conducting light signals from an external location, through water, and to a piece of pool equipment using a light guide.

18. The method of claim 17, wherein the light signals are communication signals, lighting signals, visual effect signals, and/or a sensing signals.

19. The method of claim 17, wherein the pool equipment comprises a dry electrical compartment with a light receiver, and wherein the light guide is not electronically connected to the dry electrical compartment.

20. The method of claim 17, wherein the pool equipment is at least one of a pool cleaner, a water chlorinator, a pump, a heat pump, or a pool light.
